(19) United States
(12) Patent Application Publication
(10) Pub. No.: US 2020/0365029 A1
(43) Pub. Date: Nov. 19, 2020

(54) CONFIDENCE MAP BUILDING USING SHARED DATA

(71) Applicant: FORD GLOBAL TECHNOLOGIES, LLC, Dearborn, MI (US)

(72) Inventors: Helen Elizabeth KOUROUS-HARRIGAN, Monroe, MI (US); Jeffrey Thomas REMILLARD, Ypsilanti, MI (US); Jovan Milivoje ZAGAJAC, Ann Arbor, MI (US); John WALPUCK, West Bloomfield, MI (US); Erik KILEDAL, Hillsdale, MI (US)

(21) Appl. No.: 16/416,064

(22) Filed: May 17, 2019

(51) Int. Cl. G08G 1/16; H04W 4/40; G05D 1/02; G05D 1/00

(52) U.S. Cl. CPC G08G 1/163; G08G 1/167; H04W 4/40; H04W 4/027; G05D 1/0257; G05D 1/0055; G05D 1/0231

(57) ABSTRACT

A vehicle includes a memory configured to store a dynamic occupancy grid of observed objects within a space surrounding the vehicle, the dynamic occupancy grid being generated based on information identified by sensors of the vehicle and based on information wirelessly received to the vehicle from connected actors, the connected actors including one or more connected vehicles or roadway infrastructure elements. The vehicle further includes a processor programmed to identify a maneuver space of the dynamic occupancy grid required to complete a driving maneuver responsive to intent to perform a vehicle maneuver, utilize the dynamic occupancy grid to identify obstacles within the maneuver space, and authorize the maneuver with the connected actors based on type and location of the obstacles identified within the maneuver space.

### TECHNICAL FIELD

Aspects of the disclosure generally relate to using shared data to build dynamic occupancy grids for cooperative maneuvers with connected vehicles, for use in environments such as those including uncooperative or unconnected vehicles.

### BACKGROUND

Vehicle-to-everything (V2X) is a type of communication that allows vehicles to communicate with various aspects of the traffic environment surrounding them, including other vehicles (V2V communication) and infrastructure (V2I communication). Vehicles may include radio transceivers to facilitate the V2X communication. A vehicle may utilize cameras, radios, or other sensor data sources to determine the presence or absence of objects in proximity to the vehicle. In one example, a blind spot monitor may utilize a RADAR unit to detect the presence or absence of vehicles located to the driver's side and rear, by transmitting narrow beams of high-frequency radio waves through the air and measuring how long it takes for a reflection of the waves to return to the sensor. In another example, a vehicle may utilize LiDAR to build a depth map of objects in the vicinity of the vehicle, by continually firing off beams of laser light and measuring how long it takes for the light to return to the sensor.

### SUMMARY

In one or more illustrative examples, a vehicle includes a memory configured to store a dynamic occupancy grid of observed objects within a space surrounding the vehicle, the dynamic occupancy grid being generated based on information identified by sensors of the vehicle and based on information wirelessly received to the vehicle from connected actors, the connected actors including one or more connected vehicles or roadway infrastructure elements. The vehicle further includes a processor programmed to identify a maneuver space responsive to an active vehicle maneuver intent, utilize the dynamic occupancy grid to identify obstacles within the maneuver space, and authorize the maneuver with the connected actors based on the type and location of the obstacles identified within the maneuver space.

In one or more illustrative examples, a method includes storing a dynamic occupancy grid of observed objects within a space surrounding the vehicle, the dynamic occupancy grid being generated based on information identified by sensors of the vehicle and based on information wirelessly received to the vehicle from connected actors, the connected actors including one or more connected vehicles or roadway infrastructure elements; and identifying a maneuver space of the dynamic occupancy grid required to complete a driving maneuver responsive to intent to perform a vehicle maneuver; utilizing the dynamic occupancy grid to identify obstacles within the maneuver space; and authorize the maneuver with the connected actors based on type and location of the obstacles identified within the maneuver space.

In one or more illustrative examples, a non-transitory computer readable medium includes instructions that, when executed by a computing device, cause the computing device to store a dynamic occupancy grid of observed objects within a space surrounding the vehicle, the dynamic occupancy grid being generated based on information identified by sensors of the vehicle and based on information wirelessly received to the vehicle from connected actors, the connected actors including one or more connected vehicles or roadway infrastructure elements; and identify a maneuver space of the dynamic occupancy grid required to complete a driving maneuver responsive to intent to perform a vehicle maneuver; utilize the dynamic occupancy grid to identify obstacles within the maneuver space; and authorize the maneuver with the connected actors based on type and location of the obstacles identified within the maneuver space.

### BRIEF DESCRIPTION OF THE DRAWINGS

FIG. 1 illustrates an example system for the use of shared sensor data to build dynamic occupancy grids for cooperative maneuvers with connected vehicles in environments with uncooperative or unconnected vehicles;

FIG. 2 illustrates an example arrangement of connected vehicles in an environment including unconnected vehicles;

FIG. 3 illustrates an example of awareness zones for two different connected vehicles;

FIG. 4 illustrates an example arrangement of connected vehicles and infrastructure in an environment including unconnected vehicles;

FIG. 5 illustrates an example representation of the dynamic occupancy grid;

FIG. 6 illustrates an example of a dynamic occupancy grid corresponding to the example arrangement of connected vehicles shown in FIG. 2;

FIG. 7 illustrates an alternate example of a dynamic occupancy grid representation corresponding to the example arrangement of connected vehicles shown in FIG. 2;

FIG. 8 illustrates an example process for the updating of the dynamic occupancy grid; and

FIG. 9 illustrates an example process for the execution of a maneuver by utilizing information from the dynamic occupancy grid.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The term connected vehicles refers to vehicles which can communicate data peer-to-peer in a local wireless network, or vehicle-to-vehicle (V2V). The term unconnected vehicles refers to vehicles lacking such network connectivity. Connected vehicles can share their state (position, speed, heading, intent) with other connected vehicles, as well as agree on complex maneuvers requiring sharing a conflicting resource or for establishing right-of-way. For example, vehicles with intent to change into the same lane at the same time, or vehicles performing highway merging which requires some vehicles to speed up and others to slow down, can agree on an advised action sequence via V2V using one or more established consensus algorithms.

To perform these cooperative maneuvers, connective vehicles may require not only the ability to communicate, but also situational awareness, which may include, but not be limited to, data about occupancy in adjacent lanes, and data about the planned speed and trajectory of surrounding vehicles.

However, in absence of complete penetration of connected vehicles, these maneuvers must be made with non-cooperative or non-connected vehicles which cannot participate in the wireless conversation about intent or consensus around conflicting maneuvers. Reliable situational awareness may be difficult to achieve in a mixed environment of connected vehicles and non-connected vehicles. Therefore, cooperative maneuvers may be limited to environments including only connected vehicles, a situation which is not practically achievable in the near term.

For example, in the case of three connected vehicles and one unconnected vehicle interacting in a highway merge, the unconnected vehicle may unwittingly violate a weave-in sequence agreed upon by the three connected vehicles, thereby creating a disturbance for what was supposed to be a negotiated maneuver among the vehicles.

Connected vehicles can increase the reliability and utility of cooperative maneuvers by sharing data about their immediate surroundings. A connected vehicle protocol and associated state representation is proposed which allows connected vehicles to contribute to a local situational awareness confidence map by sharing sensor data. In an example, a connected vehicle with adaptive cruise control (ACC) sensors or blind spot warning sensors may contribute to an evolving picture of the state of occupancy of the lanes within the sensor coverage space described by the vehicle's trajectory.

A state representation of objects in the environment is also proposed. The environment in which connected and automated vehicles operate may include static and dynamic obstacles. An observing agent is a location-aware vehicle or stationary node with sensors and the ability to communicate with other agents. A shared representation of dynamic objects can be developed, added to, and subtracted from, by the connected observing agents. Notably, this approach may assume a synchronous communications solution, as a shared representation of external events and dynamic actors may benefit from a concept of common time. Further aspects of the disclosure are discussed in greater detail herein.

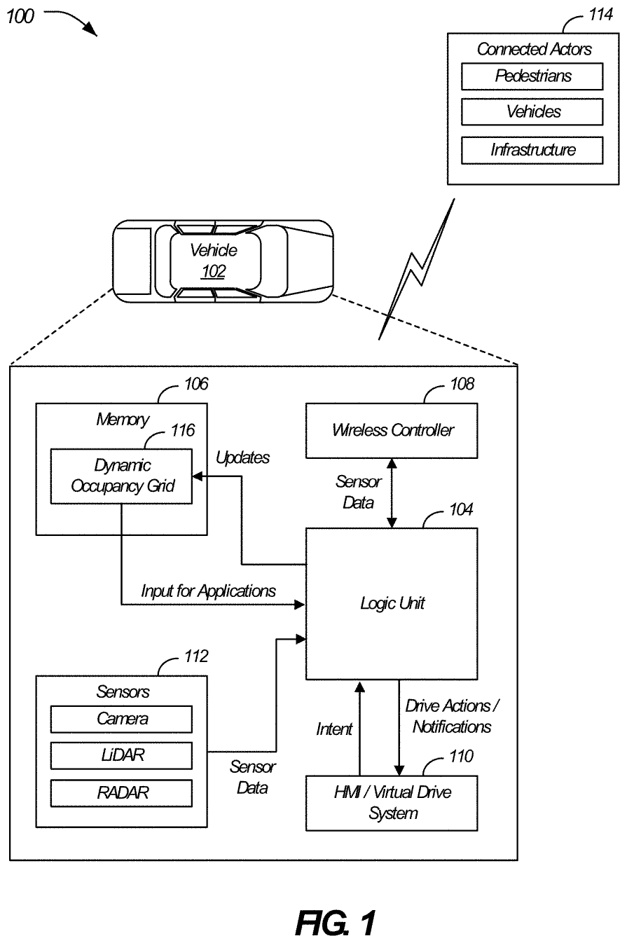

FIG. 1 illustrates an example system 100 for the use of shared sensor data to build dynamic occupancy grids 116 for cooperative maneuvers with connected vehicles 102 in environments with uncooperative or unconnected vehicles. As illustrated, the vehicle 102 include a logic unit 104, a memory 106, a wireless controller 108, a human-machine interface or virtual drive system 110, and various sensors 112. These elements may be configured to communicate over dedicated connections or vehicle buses. The wireless controller 108 may be configured to communicate with various connected actors 114, such as pedestrians, other vehicles 102, and infrastructure. By using sensor data from the local sensors 112 and also data from the connected actors 114 via the wireless controller 108, the logic unit 104 may be programmed to maintain an up-to-date dynamic occupancy grid 116, as well as to use the dynamic occupancy grid 116 as input for connected applications and to provide drive actions to the virtual drive system 110 and/or notifications to the human-machine interface 110. It should be noted that the system 100 shown in FIG. 1 is merely an example, and systems 100 including more, fewer, and different elements may be used.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a battery-electric vehicle (BEV) powered one or more electric motors, a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as VINs.

The vehicle 102 may include a logic unit 104 configured to perform and manage various vehicle 102 functions under the power of the vehicle battery and/or drivetrain. The logic unit 104 may include one or more processors configured to execute computer instructions, and may access the memory 106 or other a storage medium on which the computer-executable instructions and/or data may be maintained.

The memory 106 (also referred to as a computer-readable storage, processor-readable medium, or simply storage) includes any non-transitory (e.g., tangible) medium that participates in providing data (e.g., instructions) that may be read by the logic unit 104 (e.g., by its processor(s)). In general, a processor receives instructions and/or data, e.g., from the memory 106 and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C #, Fortran, Python, JavaScript, Perl, PL/SQL, etc. As depicted, the example logic unit 104 is represented as a discrete controller. However, the logic unit 104 may share physical hardware, firmware, and/or software with other vehicle 102 components, such that the functionality of other controllers may be integrated into the logic unit 104, and that the functionality of the logic unit 104 may be distributed across a plurality of logic units 104 or other vehicle controllers.

Various mechanisms of communication may be available between the logic unit 104 and other components of the vehicle 102. As some non-limiting examples, one or more vehicle buses may facilitate the transfer of data between the logic unit 104 and the other components of the vehicle 102. Example vehicle buses may include a vehicle controller area network (CAN), an Ethernet network, or a media-oriented system transfer (MOST) network.

A wireless controller 108 may include network hardware configured to facilitate communication between the logic unit 104 and other devices of the system 100. For example, the wireless controller 108 may include or otherwise access a cellular modem and antenna to facilitate wireless communication with a wide-area network. The wide-area network may include one or more interconnected communication networks such as a cellular network, the Internet, a cable television distribution network, a satellite link network, a local area network, and a wired telephone network, as some non-limiting examples.

Similar to the logic unit 104, the HMI/virtual drive system 110 may include various types of computing apparatus including a memory on which computer-executable instructions may be maintained, where the instructions may be executable by one or more processors (not shown for clarity). Such instructions and other data may be stored using a variety of computer-readable media. In a non-limiting example, the HMI/virtual drive system 110 may be configured to report alerts to a driver or other vehicle occupant. In another non-limiting example, the HMI/virtual drive system 110 may be configured to direct the performance of various autonomous vehicle commands received from the logic unit 104.

The logic unit 104 may receive data from various sensors 112 of the vehicle 102. As some examples, these sensors 112 may include a camera configured to provide image sensor data regarding the surroundings of the vehicle 102, a LiDAR sensor configured to utilize lasers to provide depth information regarding the surroundings of the vehicle 102, and/or RADAR sensors configured to provide object presence information with respect to various areas surrounding the vehicle 102 (e.g., for use in blind spot monitoring).

The logic unit 104 may also receive data from various connected actors 114, through use of the wireless functionality of the wireless controller 108. For example, the logic unit 104 may receive sensor data or other information from other connected vehicles 102. In another example, the logic unit 104 may receive sensor data from personal devices of pedestrians (such as smartphones, smart watches, tablet computing devices, etc.), or sensor data from infrastructure (such as roadside units, rely stations, traffic controls, etc.).

Based on the received sensor data, the logic unit 104 may be programmed to construct and/or update a dynamic occupancy grid 116. The dynamic occupancy grid 116 may be a time-varying map of observed objects within a space surrounding the vehicle 102 that is generated based on exchanged information with nearby connected actors 114. The dynamic occupancy grid 116 may indicate, from the perspective of the vehicle 102, which roadway areas are occupied and which roadway areas are available for the vehicle 102 to enter. Further aspects of the dynamic occupancy grid 116 are discussed in detail below.

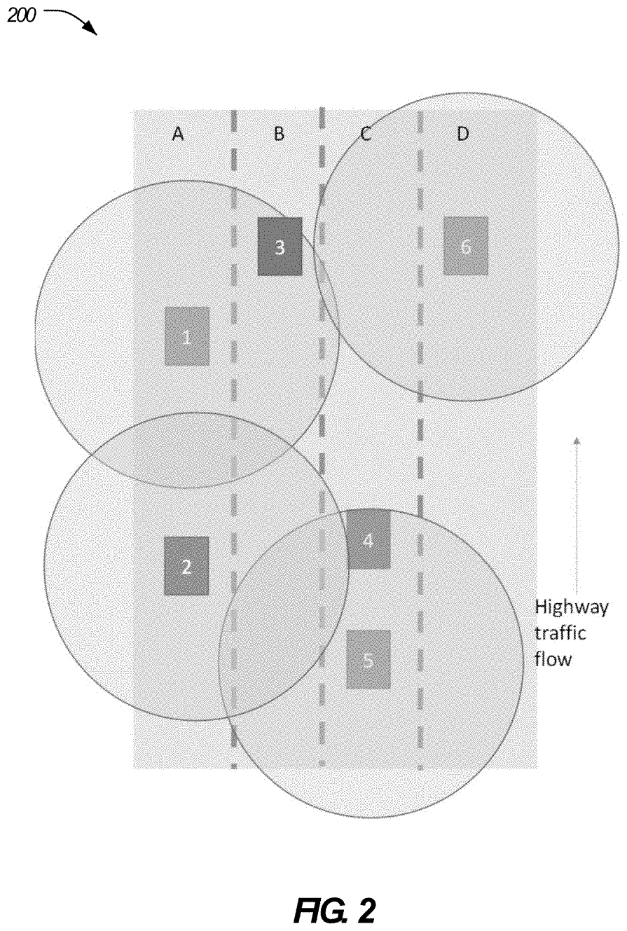

FIG. 2 illustrates an example 200 arrangement of connected vehicles 102 in an environment including unconnected vehicles. As shown, six vehicles are traveling along a roadway in a traffic flow direction (illustrated as up in the example 200). Vehicles one, two, five, and six are connected vehicles 102, while vehicles three and four are unconnected vehicles. The roadway includes four lanes of travel, A, B, C, and D. Vehicles one and two are in lane A, vehicle three is in lane B, vehicles four and five are in lane C, and vehicle six is in lane D.

As mentioned above, connected vehicles 102 may receive sensor data from other connected vehicles 102. As a result, the connected vehicles 102 may fill in gaps in their dynamic occupancy grids 116 for each other by sharing situational awareness information generated from their sensors 112. As shown in FIG. 2, the circles surrounding each of the connected vehicles 102 represent an approximate area in which each vehicle 102 can confidently measure this situational awareness information using the sensors 112.

As shown in the illustrated example, vehicle six may indicate a shared maneuver requests specifying a desired lane change left intent from lane D to lane C. Responsive to the indication of a lane change, the vehicles one, two and five may warn vehicle six of a potential hazard from unconnected vehicles three or four. For instance, vehicle four may be traveling at a speed in excess of the speed of travel of vehicle six. This may result in vehicle four overtaking vehicle six and being in roadway lane C where vehicle six intends to move. Or, vehicle three may be observed by one of the other connected vehicles 102 as having a right turn signal on, indicating that vehicle three has an intent to enter lane C adjacent to vehicle six. By vehicle six receiving sensor data from the other connected vehicles 102, the vehicle six may improve its situational awareness, increasing the confidence of shared maneuver requests.

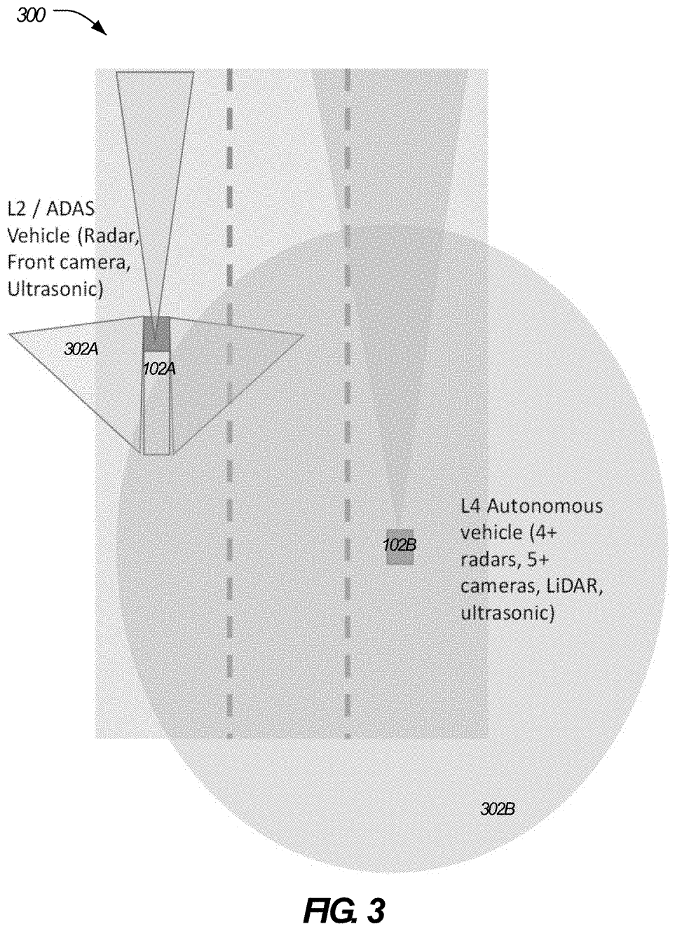

FIG. 3 illustrates an example 300 of awareness zones for two different connected vehicles 102. As shown, a first connected vehicle 102A may have a first sensor coverage area 302A, and a second connected vehicle 102B may have a second, larger, sensor coverage area 302B. Thus, the vehicles 102A and 102B each have different approximate areas in which they can confidently measure this situational awareness information using their respective sensors 112.

The first connected vehicle 102 may be a SAE level 2 vehicle having adaptive driver assistance systems (ADAS) that provide a level of automatic driver and vehicle protection. These ADAS may include adaptive cruise control (ACC), blind spot information system (BLIS), and backup assist. To implement those features, the first connected vehicle 102 may incorporate various sensors 112, such as radar, a front-facing camera, and ultrasonic sensors. Using these sensors, the vehicle 102 may have an awareness zone similar to that as shown.

The second connected vehicle 102 may be a SAE level 3 or above vehicle 102 having more complete sensor coverage than the first connected vehicle 102, in terms of parameters such as range, resolution, and degrees of coverage. To receive the additional sensor data, the second connected vehicle 102 may include sensors 112 such as multiple radars, multiple cameras, LiDAR, and ultrasonic sensors.

Based on the configuration of the vehicle 102, the shape of the sensor coverage area 302 may be identified a priori. Thus, what areas are known or unknown for sensing by each vehicle 102 may be utilized in the generation of the dynamic occupancy grid 116. For instance, a vehicle 102 may be deemed informative only for areas in which the vehicle 102 is able to sense. For other areas, sensor data from the vehicle 102 may be inferred to be of low confidence.

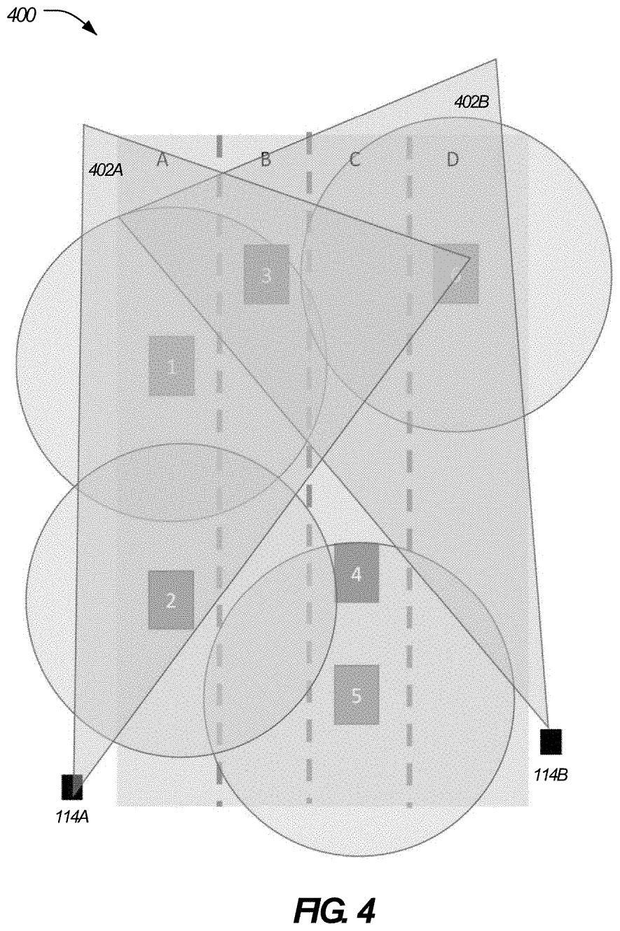

FIG. 4 illustrates an example 400 arrangement of connected vehicles 102 and infrastructure in an environment including unconnected vehicles. Similar to the example 200, six vehicles are traveling along a roadway in a traffic flow direction, where the roadway includes four lanes of travel, A, B, C, and D. Vehicles one and two are in lane A, vehicle three is in lane B, vehicles four and five are in lane C, and vehicle six is in lane D. However, as compared to the example 200, in the example 400 sensor data is further available from two instances of infrastructure 114A, 114B performing as connected actors 114. These infrastructure elements may include sensors such as cameras, radar, etc., similar to the sensors 112 that may be included in the vehicles 102, although the infrastructure elements may be installed at fixed locations along the roadway. As shown, the infrastructure 114A provides a sensor coverage area 402A, while the infrastructure 114A provides a sensor coverage area 402B.

Thus, in addition to the sensors 112 on the vehicles 102, these cameras or other sensors in the environment with the concomitant computing capability to process sensor data into situational awareness information may be available to wirelessly communicate sensor information to the connected vehicles 102 in the immediate area. Use of additional data from the infrastructure may accordingly result in additional situational awareness for the connected vehicles 102, increasing the confidence of shared maneuvers.

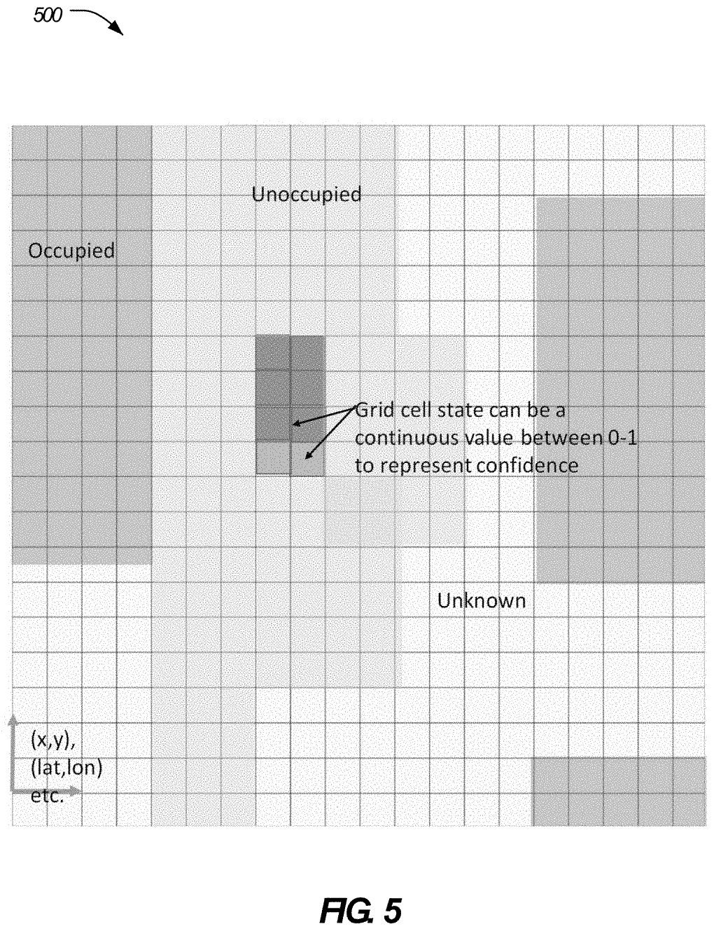

FIG. 5 illustrates an example representation of the dynamic occupancy grid 116. In general, the dynamic occupancy grid 116 may represent a time-varying state of obstacles surrounding a vehicle 102 in a traffic environment such as a roadway. The connected vehicles 102 can increase the efficiency of cooperative maneuvers by maintaining the dynamic occupancy grid 116 of observed objects within its surrounding space and by exchanging such dynamic occupancy grid 116 information with nearby connected vehicles 102.

The dynamic occupancy grid 116 may include a plurality of grid cells, where the values of each of the grid cells represent probabilistic certainties about their respective states of occupancy. As shown, the dynamic occupancy grid 116 includes a grid of squares of equal size. It should be noted that this is one example, and dynamic occupancy grids 116 having different layouts may be used. For instance, differently sizes or arranged cells may be used. In one example, the cells may vary in size. In another example, the cells may be triangular, rectangular, hexagonal, or another tessellating shape.

For each cell, the probabilistic certainties may be represented as continuous values between 0 and 1, but other representations may be used as well. These values of the grid cells may indicate, as some examples, an occupied space where the cell indicates a static object (e.g., a pothole), an occupied space where the cell indicates a dynamic object (e.g., a moving vehicle), free or unoccupied space, or space in which the state is unknown. Regarding dynamic objects, these cells may have additional properties (e.g., velocity), that enhance the view of the environment provided by the dynamic occupancy grid 116.

The dynamic occupancy grid 116 maintained by a given vehicle at time t may contain N objects. These objects may include vehicles 102 (connected or unconnected) and other traffic participants 114, as well any road objects that may impede the flow of traffic. Each object in the dynamic occupancy grid 116 may be described by a minimum set of attributes: a unique identifier, coordinates in a spatial reference system, and a confidence of the spatial reference. Examples of the representation are described below with respect to Tables 1 and 2. In these and other tables, each row may be uniquely identified by a compound key of the object identifier and time reference. However, other keys or fields may additionally or alternately be used.

A complete or partial (e.g., a spatially-relevant portion) dynamic occupancy grid 116 may be communicated in compact form (such as using a compression algorithm) amongst the vehicles 102 and/or edge infrastructure 114. In another example, the dynamic occupancy grid 116 may be stored and/or communicated using a set of tables. A sample base table for a vehicle 102 is shown in Table 1.

TABLE 1
Sample base table for vehicle 0001: Location attribute

| Object | Time reference | TTL | Spatial | | | | |
|---|---|---|---|---|---|---|---|
| Identifier | [ms] | [ms] | reference | Coord1 | Coord2 | Coord3 | Confidence |
| 0001 | t₀ | 100 | GNSS | 42.30199 | −83.23767 | 24.8 | 0.98 |
| 0002 | t₀ | 100 | 0001 | 2 | −1 | 0 | <ultrasonic |
| | | | | | | | sonar> |
| 0003 | t₀ | 100 | 0001 | 5.5 | −10 | 0 | <BSM> |

The vehicle 102 itself may be represented as the first row in the Table 1. Additional objects may then be represented as additional rows in the Table. Notably, each object in the table has a unique object identifier that may be used to reference the object. As shown, this object identifier is represented as a unique integer (e.g., 0001, 0002, 0003), but different approaches may be used as well, such as randomly generated UUID s (e.g., 2ec31a35-131d-4697-b3bd-06b69bf02b1b).

Each object further includes a time reference, which is a time at which the object was added to or last refreshed in the dynamic occupancy grid 116. This time reference may specify a time in various ways, for example as a specific time of day, or as a reference to a refresh cycle of the dynamic occupancy grid 116. Cellular vehicle-to-everything (“C-V2X”) is a short-range wireless communication technology that may be utilized for the sharing of data between vehicles 102, and between vehicles 102 and infrastructure 114, due to its high bandwidth and inherent GNSS time synchronization. In some examples, the time reference may be the GNSS time reference.

Each object may also have an expiration timestamp or time-to-live (“TTL”) value specified to indicate for how long the information regarding the object may remain useable. Accordingly, objects represented in the dynamic occupancy grid 116 may be associated with the TTL to ensure that nodes are not interacting with stale data. If the location of an object is not updated before the TTL, its grid cells may be updated to unknown space until new data for those cells is received. The grid cells may be updated at a rate to support decision-making at the speed of the affected road environment. Accordingly, objects that are not observed after a certain number of cycles, despite being in a sensor coverage area, may be aged out of the dynamic occupancy grid 116.

Each object may also include spatial reference information. A spatial reference of a location or object in the dynamic occupancy grid 116 may be expressed in different systems. The spatial reference may therefore be encoded as a reference type, and a three-dimensional coordinate of the specified reference type. In one example, the spatial reference may be represented in UTM or WGS-84 as a latitude, longitude, and height. In another example, the spatial reference may be represented an XYZ orthogonal system relative to a specified object (x, y, z), such as where x is the dimension along the forward vector of referenced object. In yet a further example, the spatial reference may be via a SAE J2735 MAP, which may include an intersection id, a lane id, and a distance to a node.

As shown in the example of Table 1, the vehicle 102 itself specifies its location using GNSS as a spatial reference. The object further expresses its coordinates as 3D GNSS coordinates. As further shown, additional objects in the dynamic occupancy grid 116 represent themselves in relative coordinates to the vehicle 102. Notably, the spatial reference for these further objects utilized the object identifier of the vehicle 102 itself as the spatial reference, indicating that the coordinates of these objects are relative to the vehicle 102 location. Using such an approach, the connected vehicles 102 may compute relative position for maneuvers based on the global location of the vehicle 102 performing the computation.

The objects represented in the dynamic occupancy grid 116 may be classified as a type with a confidence. Confidence, in general, may be expressed in terms of the origin of the data, for example: local GNSS device, BSM, LiDAR, radar, ultrasonic sonar, 2D RGB camera, kinematic projection, which in turn may be converted to a numerical value. For instance, models and/or types of the sensors may allow estimates of the error bars, or standard deviation (covariance for multiple variables), of measurements of specific sensors under specific conditions. In other words, the confidence of a measurement may be based on a sensor type and also the sensor model. Indeed, measurements may be stored as (<measurement>, <error or STD of that measurement>). Each object type may have additional attributes, expressed as a value and the confidence in the value. As shown in the Table 1, the vehicle 0001 is certain of its location to the current level of accuracy of its GNSS system. The next entry is for vehicle 0002, and indicates that the second vehicle occupies a space two meters to the right and one meter behind the first vehicle, as detected by ultrasonic sonar. The third entry is for vehicle 0003, and indicates that the third vehicle is ten meters behind and five and a half meters to the right of the first vehicle.

This relative coordinate information may be converted from GNSS coordinates received in a BSM message. These messages may populate the dynamic occupancy grid 116 in conjunction with the TTLs synchronized per the time references ensure that all connected actors in the area share a similar, if not identical, dynamic occupancy grid 116 at any given point in time. Refresh rates of 10 Hz to 100 Hz may be used, in an example, in the updating of the data in the dynamic occupancy grid 116. Between receiving messages, locations of dynamic object having velocity or other information can be estimated using kinematic projection based on associated speed, acceleration, and heading data.

Further classification of occupied space can be evolved with the aid of highly automated vehicles 102 and/or infrastructure edge compute nodes equipped with high definition sensors analogous to connected and automated vehicles (e.g., lidar, radar, camera, etc.) that can detect and classify objects in the environment. These may include connected actors 114 or also unconnected actors, such as pedestrians, automobiles, motorcycles, dogs, deer, geese, or other moving or static objects.

Moreover, by incorporating received SAE J2735 MAP messages into the data of the dynamic occupancy grid 116, vehicles 102 may be able to calculate allowed maneuvers of the observed objects in certain areas (intersections). This could be considered an extended attribute of that object at that time, which could be used when calculating risks of collaborative maneuvers. The values in the grid cells of the dynamic occupancy grid 116 may therefore also represent pending or active traffic maneuvers, based on intents shared by other actors. This data may be based on intents shared by other actors. For instance, if a vehicle intends to perform a lane shift to an adjacent lane, the grid cells of that adjacent lane may be marked as requested for the lane shift traffic maneuver.

Further information regarding objects may be specified in one or more extended tables. Table 2 illustrates a sample extended table for the first vehicle 0001 of Table 1, providing classification information for the objects indicated in the location attribute Table 1:

TABLE 2
Sample extended table for vehicle 0001: Classification attribute

| Object | Time | | | TTL |
|---|---|---|---|---|
| Identifier | reference | Classification | Confidence | [ms] |
| 0001 | t₀ | L4-AV | 1.0 | ∞ |
| 0002 | t₀ | Unconnected | 0.5 | 10000 |
| | | vehicle | | |

As shown in the Table 2, the vehicle 0001 is certain of its classification with a confidence of one, and with a TTL of infinity. Also shown, the vehicle 0002 occupies a space from which no BSMs have been observed for the last ten seconds, so this is likely a representation of an unconnected vehicle. The confidence of this value is not as certain as that of the vehicle itself, but the first vehicle will reconsider the classification in ten seconds from the time reference pursuant to the specified TTL. It should be noted that this is only one example of an extended table. Additional extended tables may be maintained for other attributes, such as attributes such as geometry, velocity, and/or acceleration.

At fixed time intervals, the local dynamic occupancy grid 116 may be updated, or optimized, by the vehicle 102. This optimization may include removing entries that have expired (e.g., where the time reference+TTL>current time). Additionally, non-expired entities that have not been observed for a specified number of timesteps may also be removed. Entries that are outside the spatial area of interest for the vehicle 102 may also be removed. Also, entries that likely describe the same object may be merged. This may occur where multiple objects are shown at the same location, as one heuristic. Moreover, spatial references may be converted to a simpler form (e.g., from GNSS to relative X, Y to the vehicle 102 itself.) As another optimization, calculated kinematic projections for future timesteps may also be added to the dynamic occupancy grid 116.

The vehicles 102 and infrastructure may be configured to send sensor data and/or the tabular information of the dynamic occupancy grid 116 to one another in a distributed synchronized approach. This communication of map data may be optimized in various ways. To preserve communication channel bandwidth, shared map information content may be reduced by eliminating content which has not changed since the last time step, by converting spatial references to alternate spatial reference (e.g., from a global WGS-84 format to XYZ relative to sender), or by a combination of these approaches (e.g., transmitting only a changed y-coordinate of vehicle in a nearby lane). As another optimization, the coordinate expressing distance from ground level may be eliminated in most driving situations (e.g., apart from multiple level roadways or interchanges). As a further optimization, the UUIDs of the objects may be shortened to a shortest set of bits which uniquely identify the objects among the currently observed objects. A recipient without a match on this reduced bitset may request the sender to transmit the full bit set (128 bits). Another optimization may be to use a default TTL by attribute type, such that TTL is not necessary to be provided for each object. As another possibility, object attributes may be transmitted on demand, optionally within a defined spatial boundary, instead of on a fixed frequency. For example, a vehicle 102 receiving spatial references of an observed object may inquire further information (classification, geometry) from sender, or a vehicle 102 may inquire about extended attributes of objects within a certain range of itself. Nearby vehicles 102 similarly without extended map information about the same observed object may also receive the extended map information.

This distributed synchronization aids vehicles 102 in reliably reaching consensus on traffic maneuvers based on the data in their respective dynamic occupancy grid 116. With respect to application of the dynamic occupancy grid 116 to cooperative maneuvers, when a cooperative maneuver is planned between two or more connected vehicles 102, a confidence can be established (and continually updated) by validating the maneuver against the occupancy information of the dynamic occupancy grid 116. Interrogating the dynamic occupancy grid 116 may accordingly provide a confirmation for maneuvers into unoccupied grid cells with classification confidence higher than a predefined threshold, and may provide a rejection for maneuvers into grid cells with unknown state or with state of occupation with insufficient confidence, or into grid cells with an occupied state. The vehicles 102 may also adapt onboard driving or HMI systems 110 based on confidence levels and desired maneuver (e.g., pre-charge brakes, advise to “proceed with caution”).

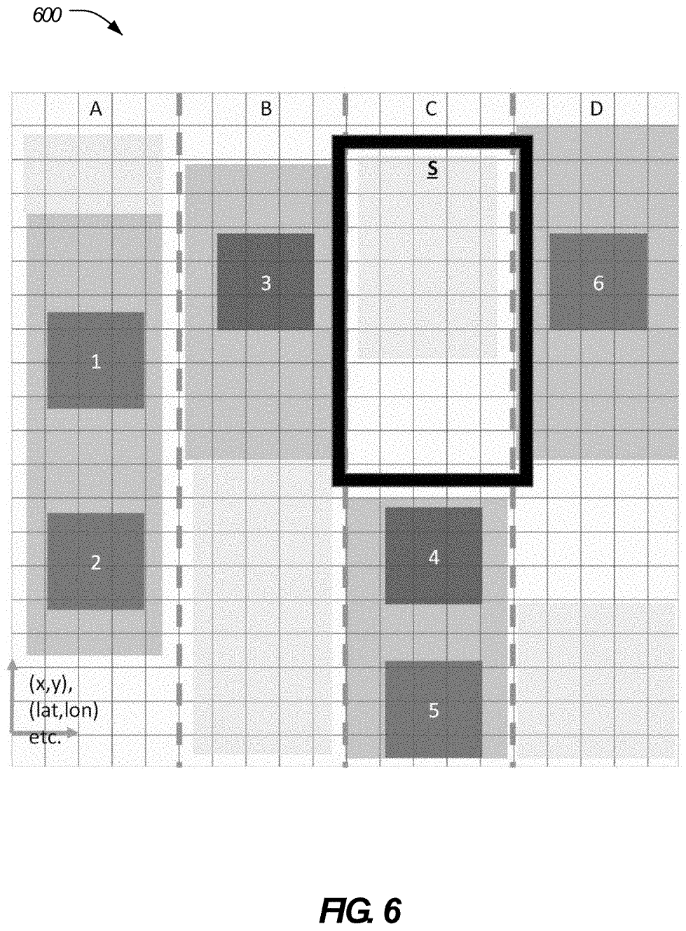

FIG. 6 illustrates an example 600 of a dynamic occupancy grid 116 representation corresponding to the example 200 arrangement of connected vehicles 102 shown in FIG. 2. As shown, the space surrounding each of the six vehicles is indicated as being occupied space. Additionally, unoccupied space is indicated in the four lanes of travel, A, B, C, and D, in front of or behind the vehicles. Moreover, certain locations are shown as being unknown, e.g., in areas distant from the vehicles 102 or within blind spots of the vehicles 102 that are not also covered by sensor coverage areas 302 from other vehicles 102.

Similar to as discussed with respect to the example 200, the vehicle six may indicate a shared maneuver requests specifying a desired lane change left intent from lane D to lane C. As shown, a region of requested space ‘S’ for the lane change maneuver is illustrated on the dynamic occupancy grid 116, indicating an example region that would be required to be in the unoccupied status for the lane change maneuver to be performed.

Here, the dynamic occupancy grid 116 may be utilized to perform an example vehicle maneuver in a traffic environment. From the perspective of vehicle six, the order of events for the lane change may occur as follows. The vehicle six may express intent to maneuver to the left. The vehicle may then determine the relevant space ‘S’ needed to complete the maneuver, as represented by the boxed area in the example 600. The vehicle may then reference the dynamic occupancy grid 116 in and around ‘S’. As indicated, the included area within the space is about ˜60% unoccupied, and about ˜40% unknown. Notably, vehicles three and four are both in positions where they could quickly occupy part or all of ‘S’. Since vehicles three and four are unconnected, vehicle six cannot be confident that vehicles three and four will not maneuver into the space ‘S’. As a result, the vehicle six may decide that the maneuver is not urgent enough and may wait until later to change lanes.

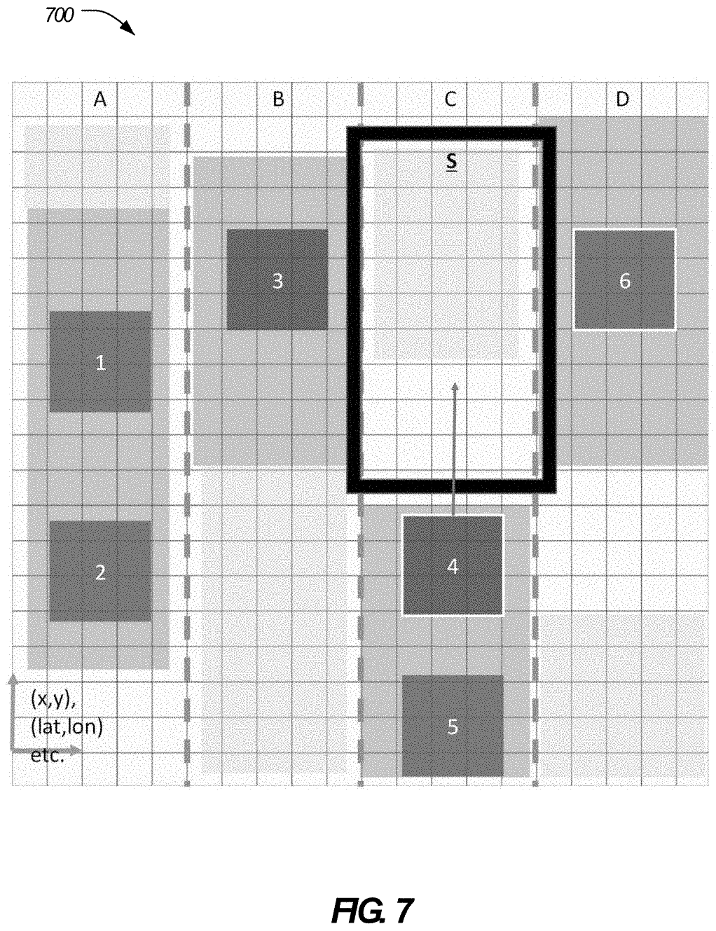

FIG. 7 illustrates an alternate example 700 of a dynamic occupancy grid 116 representation corresponding to the example 200 arrangement of connected vehicles 102 shown in FIG. 2. In the alternative example, still from the perspective of vehicle six, the vehicle expresses intent to maneuver to the left. The vehicle may again then determine the relevant space ‘S’ needed to complete the maneuver, as represented by the boxed area in the example 700. The vehicle may then reference the dynamic occupancy grid 116 in and around ‘S’.

Here, vehicle six may utilize sensor data transmitted from vehicle five that shows that vehicle four is traveling at a high rate of speed. The vehicle six may use this information to project a view of the dynamic occupancy grid 116 forward in time to see a potential issue with vehicle four being in the space ‘S’. As a result, the vehicle six may decide that the maneuver is not urgent enough and may wait until later to change lanes.

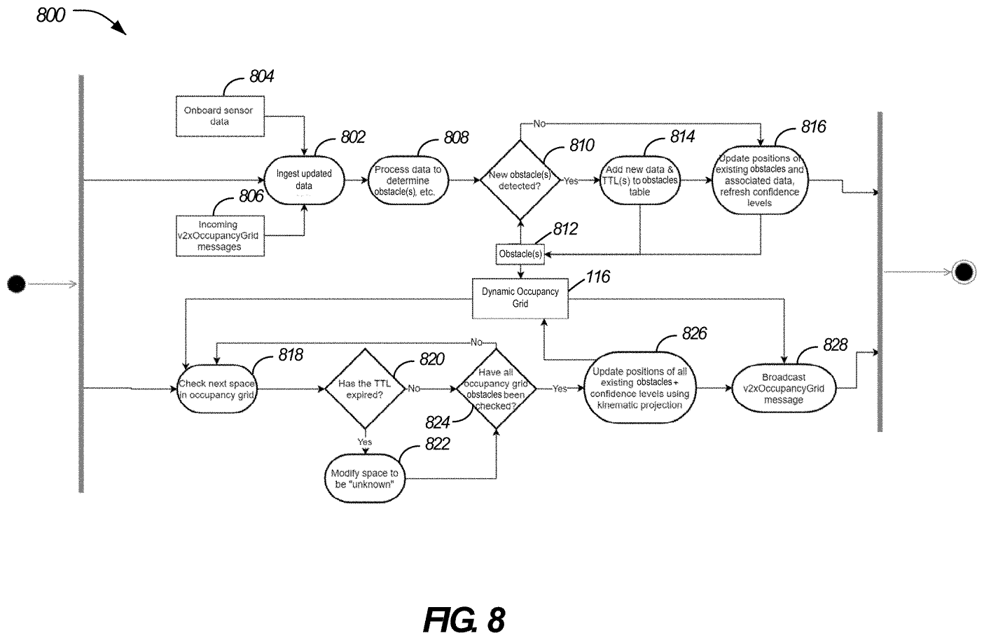

FIG. 8 illustrates an example process 800 for the updating of the dynamic occupancy grid 116. In an example, the process 800 may be performed by the logic unit 104 of a connected vehicle 102 in the context of the system 100. The process 800 includes two flows: a first flow based on the receipt of new data that may run responsive to receipt of data or periodically, and a second flow that runs periodically to keep the dynamic occupancy grid 116 up-to-date.

The first flow begins at operation 802, in which the logic unit 104 ingests updated data. This data may be raw environmental sensor data received, in one example, from the sensors 112 of the vehicle 102 as shown at 804. In another example, this data may be received as V2X occupancy grid messages received from other vehicles 102 or from connected actors 114 via the wireless controller 108, as shown at 806. The V2X occupancy grid messages may include, in an example, raw environmental sensor data from sensors of infrastructure, pedestrians, or other vehicles 102. Additionally or alternately, the V2X occupancy grid messages may include table data, such as the table data discussed above with respect to Tables 1 and 2.

At 808, the logic unit 104 processes the received data to determine the presence or absence of obstacles. In an example, the logic unit 104 may utilize LiDAR, camera, blind spot monitor, or other sources of data to identify objects within the vicinity of the vehicle 102.

The logic unit 104 determines whether any new obstacles have been detected at 810. In an example, the logic unit 104 may compare the received data to the obstacle table 812 maintained by the vehicle 102 specifying the listed objects previously identified by the vehicle 102 according to local or received data. If objects have been identified at 808 that are not included in the current obstacle table 812 representation stored by the vehicle 102, then control passes to operation 814. If no new obstacles have been identified, control passes to operation 816.

At operation 814, the logic unit 104 adds new data and TTL information to the obstacles table 812. For instance, new objects may be assigned information as discussed above with respect to the Tables 1 and 2 and FIG. 5. As one example, default TTL values may be assigned to the objects by attribute type. As another example, location data may be assigned to the objects based on the sensor data. As a further example, random UUID identifiers may be assigned to the objects to give them unique identities.

At 816, the logic unit 104 updates the obstacles table 812. This may include, for example, updating the positions of existing dynamic obstacles using stored velocity information and associated data in the obstacles table 812. This may also include refreshing confidence values in the obstacles table 812. For instance, confidence values may reduce the longer it has been since an object was last seen. After operation 816, the first flow is complete.

The second flow begins at operation 818, in which the logic unit 104 periodically checks a next space in the dynamic occupancy grid 116. In an example, the logic unit 104 may iterate through the cells of the dynamic occupancy grid 116 in the second flow to perform updates to each of the cells. At 820, the logic unit 104 determines whether the TTL for the cell has expired. In an example, the logic unit 104 may compute whether the time reference for the underlying object for the cell plus the TTL for the underlying object is greater than the current time. If so, the TTL has expired and control passes to operation 822 to set the cell space to unknown (e.g., from occupied). If the TTL has not expired, and in the alternative after operation 822, control passes to operation 824 to determine whether all cells of the dynamic occupancy grid 116 have been checked. If not, control returns to operation 818. Once all of the cells have been checked, however, control passes to operation 826.

At 826, similar to as done at operation 816, the logic unit 104 updates the positions of existing obstacles and confidence levels in the dynamic occupancy grid 116. These changes may be reflected in the dynamic occupancy grid 116 as well. At operation 828, the logic unit 104 broadcasts V2X occupancy grid messages via the wireless controller 108 to update other vehicles 102 of the current status of obstacles as maintained by the vehicle 102. This data may be received by other vehicles 102, as discussed above with respect to operations 802 and 806 of the first flow. After operation 828, the second flow is complete.

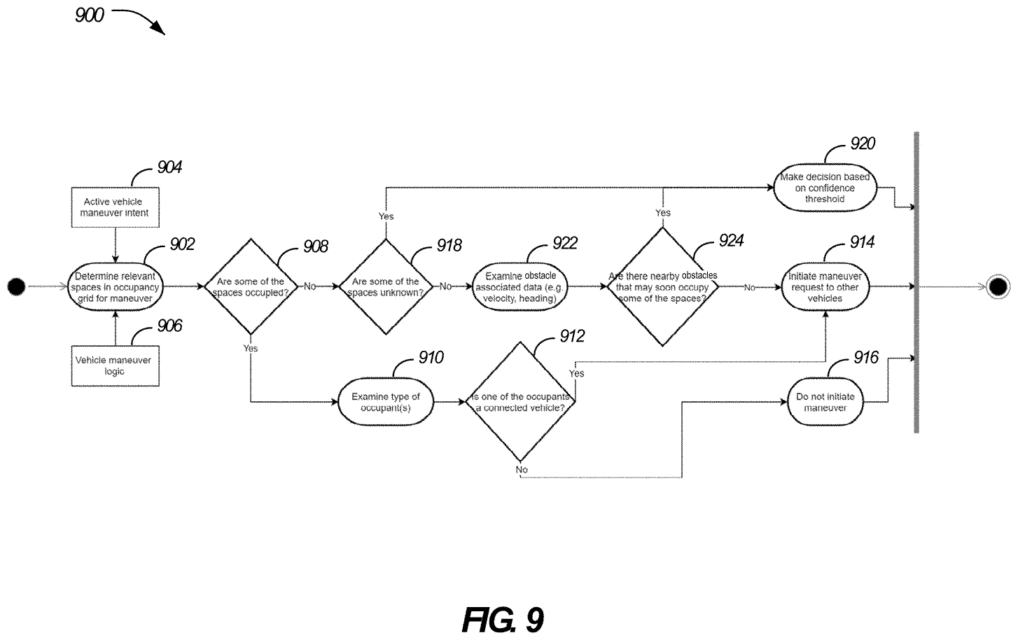

FIG. 9 illustrates an example process 900 for the execution of a maneuver by utilizing information from the dynamic occupancy grid 116. As with the process 800, the process 900 may be performed by the logic unit 104 of a connected vehicle 102 in the context of the system 100.

At operation 902, the logic unit 104 determines relevant spaces in the dynamic occupancy grid 116 for a maneuver. In an example, the maneuver may be performed responsive to receipt of an active vehicle maneuver intent. For instance, the intent may be received based on operator input to manual controls of the vehicle 102, such as a driver selecting a turn signal or changing the gear selection. In another example, the intent may be determined based on a navigation system providing directions to an intended destination.

In yet a further example, the intent may be determined based on a drive action requested by the virtual driver system 110. For instance, for every vehicle 102 or vehicle 102 class, there may be a library of maneuvers that are possible or desirable. These maneuvers may be looked up in vehicle maneuver logic 906 based on the maneuver intent 904. Example maneuvers may include to merge into higher speed lane, to merge into lower speed lane, or to perform a U-turn, as some examples. It may be possible for an autonomous vehicle to calculate maneuvers on the fly, but in other examples a connected vehicle may look up the maneuver to determine what space is required for performing the maneuver. For instance, a lane change may require space to the side of the vehicle, while a backup maneuver may require space behind the vehicle 102.

Based on the identified space requirements, the logic unit 104 may identify the specific cells of the dynamic occupancy grid 116 that are required to perform the maneuver. An example of a space ‘S’ required for a maneuver is illustrated in FIGS. 6 and 7.

Next, at operation 908, the logic unit 104 determines whether some of the space for the maneuver is indicated as being occupied in the dynamic occupancy grid 116. In an example, the logic unit 104 accesses the cells of the dynamic occupancy grid 116 to make the determination. If some of the spaces are occupied, control passes to operation 910 to examine the types of the occupant or occupants of the occupied cells. The type information may be maintained in the dynamic occupancy grid 116 or in the obstacle tables as discussed above. If, at operation 912, one of these occupants is a connected vehicle 102, then control passes to operation 914 to initiate a maneuver request with the other connected vehicle 102. The connected vehicles 102 may accordingly make an affirmative decision regarding use of the required space. For instance, the connected vehicles 102 occupying the space may move out of the way to allow the maneuver to be completed. With respect to the initiation of a maneuver request among connected vehicles 102, it should be noted that a cooperative maneuver involving multiple vehicles requires positive agreement on the part of all affected observers and participants that the maneuver can be performed.

If, however, one or more occupants of the required space are not connected vehicles 102, no negotiation for the space will be possible. Accordingly, control passes to operation 916 to avoid performing the maneuver. It should be noted, however, that as the active maneuver intent may remain, the process 900 may repeat at a later time and at that time the obstacle may no longer be an issue for performing the maneuver.

Returning to operation 908, if none of the spaces are occupied, the logic unit 104 further determines at 918 whether any of the required spaces are of unknown status where the vehicle 102 lacks information about the contents of the space. If so, control passes to operation 920, in which the logic unit 104 may make a determination on whether to perform the maneuver based on a confidence threshold for the space. For instance, if the logic unit 104 determines that the space is likely empty with a high confidence (e.g., over 90%, over 95%, etc.), the logic unit 104 may direct the vehicle 102 to attempt the maneuver. Again, if the maneuver is avoided, the maneuver may be tried again so long as the active maneuver intent remains.

Referring back to operation 918, if all of space is of known status, control passes to operation 922. At operation 922, the logic unit 104 examines the data associated with the obstacles (e.g., velocity, heading, etc.) to project the future location of dynamic obstacles. For instance, if a dynamic obstacle is heading in a direction at a given speed, then the logic unit 104 may infer a future position of the dynamic obstacle according to that information. At operation 924, the logic unit 104 determines whether any of the obstacles may soon occupy any of the space required for the maneuver. If so, control passes to operation 920 to elect whether or not to proceed based on how confident the logic unit 104 finds the projected locations of the dynamic obstacles. If not, control passes to operation 914 to initiate a maneuver request with the other connected vehicle 102. This may allow the other vehicles 102 on the roadway to be informed of the maneuver to be performed by the vehicle 102.

Accordingly, the connected vehicles 102 and edge nodes may maintain an evolving dynamic occupancy grid 116 of obstacles in the environment for use in cooperative maneuver safety assessment. The dynamic occupancy grid 116 may be updated using data received from sensors 112 of the vehicle 102 as well as by wirelessly sharing information regarding obstacles in a driving environment. The distributed synchronization of the dynamic occupancy grid 116 across many actors may enable confident consensus for the vehicle maneuvers. Moreover, using the dynamic occupancy grid 116, connected vehicles 102 may evaluate the confidence of cooperative maneuvers in the presence of unconnected vehicles.

Computing devices described herein, such as the logic unit 104, generally include computer-executable instructions where the instructions may be executable by one or more computing devices such as those listed above. Computer-executable instructions may be compiled or interpreted from computer programs created using a variety of programming languages and/or technologies, including, without limitation, and either alone or in combination, Java, C, C++, C #, JavaScript, Python, Perl, PL/SQL, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
a memory configured to store a dynamic occupancy grid of observed objects within a space surrounding the vehicle, the dynamic occupancy grid being generated based on information identified by sensors of the vehicle and based on information wirelessly received to the vehicle from connected actors, the connected actors including one or more connected vehicles or roadway infrastructure elements; and
a processor programmed to
identify a maneuver space of the dynamic occupancy grid required to complete a driving maneuver responsive to intent to perform a vehicle maneuver,
utilize the dynamic occupancy grid to identify obstacles within the maneuver space, and
authorize the maneuver with the connected actors based on type and location of the obstacles identified within the maneuver space.

2. The vehicle of claim 1, wherein the processor is further programmed to identify the maneuver space using a lookup of an identifier of the vehicle maneuver into a database of vehicle maneuver logic specifying maneuver spaces for corresponding maneuvers.

3. The vehicle of claim 1, wherein the processor is further programmed to:
responsive to determining per the dynamic occupancy grid that at least a subset of the maneuver space is occupied by a connected vehicle, initiate a maneuver request to the connected vehicle to cooperatively perform the maneuver; and
responsive to determining per the dynamic occupancy grid that at least a subset of the maneuver space is occupied by an object other than a connected vehicle, refrain from initiating the maneuver.

4. The vehicle of claim 1, wherein the processor is further programmed to, responsive to determining per the dynamic occupancy grid that at least a subset of the maneuver space is of an unknown occupied state, determine whether to proceed with the maneuver based on a confidence that the maneuver space is unoccupied exceeding a predefined confidence threshold.

5. The vehicle of claim 1, wherein the processor is further programmed to:
responsive to determining per the dynamic occupancy grid that the maneuver space is unoccupied and not of an unknown state, identify whether any dynamic obstacles having a velocity or heading, identified per the dynamic occupancy grid, will occupy the maneuver space during a time that the maneuver space would be used by the vehicle; and
if so, determine whether to proceed with the maneuver based on a confidence that the maneuver space is unoccupied exceeding a predefined confidence threshold.

6. The vehicle of claim 1, wherein the processor is further programmed to, responsive to receipt of the information identified by sensors of the vehicle or the on information wirelessly received to the vehicle from connected actors, update the dynamic occupancy grid to include additional objects identified by the information but not indicated in the dynamic occupancy grid.

7. The vehicle of claim 1, wherein the processor is further programmed to update positions of dynamic obstacles in the dynamic occupancy grid according to velocity or heading information for objects maintained for the dynamic occupancy grid.

8. The vehicle of claim 1, wherein data for object identified by the dynamic occupancy grid includes a time-to-live value specified to indicate for how long the information regarding the object remains useable, and the processor is further programmed to remove objects from the dynamic occupancy grid by changing a status to unknown occupancy responsive to expiration of the object pursuant to the time-to-live value.

9. A method comprising:
storing a dynamic occupancy grid of observed objects within a space surrounding the vehicle, the dynamic occupancy grid being generated based on information identified by sensors of the vehicle and based on information wirelessly received to a vehicle from connected actors, the connected actors including one or more connected vehicles or roadway infrastructure elements; and
identifying a maneuver space of the dynamic occupancy grid required to complete a driving maneuver responsive to intent to perform a vehicle maneuver;
utilizing the dynamic occupancy grid to identify obstacles within the maneuver space; and
authorizing the maneuver with the connected actors based on type and location of the obstacles identified within the maneuver space.

10. The method of claim 9, further comprising identifying the maneuver space using a lookup of an identifier of the vehicle maneuver into a database of vehicle maneuver logic specifying maneuver spaces for corresponding maneuvers.

11. The method of claim 9, further comprising:
responsive to determining per the dynamic occupancy grid that at least a subset of the maneuver space is occupied by a connected vehicle, initiating a maneuver request to the connected vehicle to cooperatively perform the maneuver;
responsive to determining per the dynamic occupancy grid that at least a subset of the maneuver space is occupied by an object other than a connected vehicle, refraining from initiating the maneuver; and
responsive to determining per the dynamic occupancy grid that at least a subset of the maneuver space is of an unknown occupied state, determining whether to proceed with the maneuver based on a confidence that the maneuver space is unoccupied exceeding a predefined confidence threshold.

12. The method of claim 9, further comprising:
responsive to determining per the dynamic occupancy grid that the maneuver space is unoccupied and not of an unknown state, identifying whether any dynamic obstacles having a velocity or heading, identified per the dynamic occupancy grid, will occupy the maneuver space during a time that the maneuver space would be used by the vehicle; and
if so, determining whether to proceed with the maneuver based on a confidence that the maneuver space is unoccupied exceeding a predefined confidence threshold.

13. The method of claim 9, further comprising:
responsive to receipt of the information identified by sensors of the vehicle or the on information wirelessly received to the vehicle from connected actors, updating the dynamic occupancy grid to include additional objects identified by the information but not indicated in the dynamic occupancy grid; and
one or more of:
(i) updating positions of dynamic obstacles in the dynamic occupancy grid according to velocity or heading information for objects maintained for the dynamic occupancy grid;
(ii) updating velocities of dynamic obstacles in the dynamic occupancy grid according to acceleration information for objects maintained for the dynamic occupancy grid; or
(iii) updating confidence values of dynamic obstacles in the dynamic occupancy grid according to a lack of continued data being received for the dynamic obstacles.

14. The method of claim 9, wherein data for object identified by the dynamic occupancy grid includes a time-to-live value specified to indicate for how long the information regarding the object remains useable, and further comprising removing objects from the dynamic occupancy grid by changing a status to unknown occupancy responsive to expiration of the object pursuant to the time-to-live value.

15. A non-transitory computer readable medium comprising instructions that, when executed by a computing device, cause the computing device to:
store a dynamic occupancy grid of observed objects within a space surrounding the vehicle, the dynamic occupancy grid being generated based on information identified by sensors of the vehicle and based on information wirelessly received to a vehicle from connected actors, the connected actors including one or more connected vehicles or roadway infrastructure elements; and
identify a maneuver space of the dynamic occupancy grid required to complete a driving maneuver responsive to intent to perform a vehicle maneuver;
utilize the dynamic occupancy grid to identify obstacles within the maneuver space; and
authorize the maneuver with the connected actors based on type and location of the obstacles identified within the maneuver space.

16. The medium of claim 15, further comprising instructions that, when executed by the computing device, cause the computing device to identify the maneuver space using a lookup of an identifier of the vehicle maneuver into a database of vehicle maneuver logic specifying maneuver spaces for corresponding maneuvers.

17. The medium of claim 15, further comprising instructions that, when executed by the computing device, cause the computing device to:
responsive to determining per the dynamic occupancy grid that at least a subset of the maneuver space is occupied by a connected vehicle, initiate a maneuver request to the connected vehicle to cooperatively perform the maneuver;
responsive to determining per the dynamic occupancy grid that at least a subset of the maneuver space is occupied by an object other than a connected vehicle, refrain from initiating the maneuver; and
responsive to determining per the dynamic occupancy grid that at least a subset of the maneuver space is of an unknown occupied state, determine whether to proceed with the maneuver based on a confidence that the maneuver space is unoccupied exceeding a predefined confidence threshold.

18. The medium of claim 15, further comprising instructions that, when executed by the computing device, cause the computing device to:
responsive to determining per the dynamic occupancy grid that the maneuver space is unoccupied and not of an unknown state, identify whether any dynamic obstacles having a velocity or heading, identified per the dynamic occupancy grid, will occupy the maneuver space during a time that the maneuver space would be used by the vehicle; and
if so, determine whether to proceed with the maneuver based on a confidence that the maneuver space is unoccupied exceeding a predefined confidence threshold.

19. The medium of claim 15, further comprising instructions that, when executed by the computing device, cause the computing device to:
responsive to receipt of the information identified by sensors of the vehicle or the on information wirelessly received to the vehicle from connected actors, update the dynamic occupancy grid to include additional objects identified by the information but not indicated in the dynamic occupancy grid; and
one or more of to:
(iv) update positions of dynamic obstacles in the dynamic occupancy grid according to velocity or heading information for objects maintained for the dynamic occupancy grid;
(v) update velocities of dynamic obstacles in the dynamic occupancy grid according to acceleration information for objects maintained for the dynamic occupancy grid; or
(vi) update confidence values of dynamic obstacles in the dynamic occupancy grid according to a lack of continued data being received for the dynamic obstacles.

20. The medium of claim 15, wherein data for object identified by the dynamic occupancy grid includes a time-to-live value specified to indicate for how long the information regarding the object remains useable, and further comprising instructions that, when executed by the computing device, cause the computing device to remove objects from the dynamic occupancy grid by changing a status to unknown occupancy responsive to expiration of the object pursuant to the time-to-live value.
